(19) United States
(12) Patent Application Publication
(10) Pub. No.: US 2019/0283714 A1
(43) Pub. Date: Sep. 19, 2019

(54) VEHICLE CLEANER

(71) Applicant: Koito Manufacturing Co., Ltd., Tokyo (JP)

(72) Inventors: Yasuhiro Ichikawa, Shizuoka-shi (Shizuoka) (JP); Riichiro Miura, Shizuoka-shi (Shizuoka) (JP)

(21) Appl. No.: 16/295,738

(22) Filed: Mar. 7, 2019

(30) Foreign Application Priority Data
Mar. 14, 2018 (JP) 2018-046453

(51) Int. Cl. B60S 1/52; B08B 3/02; B60S 1/56; B60S 1/66

(52) U.S. Cl. CPC B60S 1/52; B60S 1/66; B60S 1/56; B08B 3/02

(57) ABSTRACT

A vehicle cleaner includes: a cylindrical first bracket provided within an opening of a bumper; an actuator including a cylinder and a piston; an injection nozzle provided near a tip of the piston to inject a cleaning liquid toward a cleaning target of the vehicle in a state where the piston protrudes from the opening; a cover provided at the tip of the piston to cover the opening in a state where the piston is drawn into the cylinder; and a second bracket attachable to the vehicle body panel and configured to position the actuator relative to the opening in a state where the second bracket is engaged with the first bracket. The first bracket includes a first attachment portion and a second attachment portion, and is attachable to the vehicle body panel by the first attachment portion and the second attachment portion.

### CROSS-REFERENCE TO RELATED APPLICATIONS

This application is based on and claims priority from Japanese Patent Application No. 2018-046453, filed on Mar. 14, 2018, with the Japan Patent Office, the disclosure of which is incorporated herein in its entirety by reference.

### TECHNICAL FIELD

The present disclosure relates to a vehicle cleaner.

### BACKGROUND

A vehicle headlamp cleaner has been known in, for example, Japanese Patent Laid-Open Publication No. 2015-151089.

### SUMMARY

The headlamp cleaner of Japanese Patent Laid-Open Publication No. 2015-151089 includes a cylindrical cylinder, a piston slidably supported by the cylinder, an injection nozzle and a nozzle cover that are provided at the tip of the piston, and a bracket for positioning the piston relative to the bumper of the vehicle. In this headlamp cleaner, when the bracket is detached from the bumper, the bracket may hinder the smooth operation of the piston.

An object of the present disclosure is to provide a vehicle cleaner which does not hinder an operation of an actuator even when a bracket for positioning the actuator is detached from a vehicle body panel.

In order to accomplish the object described above, the present disclosure provides a vehicle cleaner including: a first bracket having a cylindrical shape and provided within an opening formed in a portion of a vehicle body panel of a vehicle; an actuator including a cylinder supported by the first bracket and a piston supported so as to freely reciprocate in the cylinder; an injection nozzle provided near a tip of the piston and configured to inject a cleaning liquid toward a cleaning target of the vehicle in a state where the piston protrudes from the opening; a cover provided at the tip of the piston and configured to cover the opening in a state where the piston is drawn into the cylinder; and a second bracket attachable to the vehicle body panel and configured to position the actuator relative to the opening in a state where the second bracket is engaged with the first bracket, wherein the first bracket includes a first attachment portion and a second attachment portion which are arranged at positions rotationally symmetrical to each other with respect to a reciprocation direction of the piston, and is attachable to the vehicle body panel by the first attachment portion and the second attachment portion.

According to the present disclosure, it is possible to provide a vehicle cleaner which does not hinder the operation of the actuator even when the bracket (second bracket) for positioning the actuator is detached from the vehicle body panel.

In addition, in the vehicle cleaner of the present disclosure, the first bracket may include a first positioning portion that positions the actuator relative to the second bracket, and the second bracket may include a second positioning portion in a shape that conforms to a shape of the first positioning portion.

According to this configuration, the first positioning portion and the second positioning portion are engaged with each other, so that the actuator may be easily positioned relative to the opening of the vehicle body panel.

In addition, in the vehicle cleaner of the present disclosure, the first bracket may include a first rectangular frame body as the first positioning portion, and the second bracket may include a second rectangular frame body in a shape that conforms to a shape of the first rectangular frame body, as the second positioning portion.

It is preferable to include these components as the first positioning portion and the second positioning portion.

In addition, in the vehicle cleaner of the present disclosure, the first bracket may include a guide protrusion that extends along the reciprocation direction of the piston, as the first positioning portion, and the second bracket may include a guide groove that extends along the reciprocation direction and allows the guide protrusion to be inserted therethrough, as the second positioning portion.

It is preferable to include these components as the first positioning portion and the second positioning portion.

In addition, in the vehicle cleaner of the present disclosure, the second bracket may have an abutment surface onto which the first bracket abuts when the first bracket is engaged with the second bracket along the reciprocation direction of the piston.

According to this configuration, the actuator may be easily positioned in the reciprocation direction of the actuator, for example, such that the cover fixed to the tip of the actuator is flush with the vehicle body panel.

According to the present disclosure, it is possible to provide a vehicle cleaner which does not hinder the operation of the actuator even when the bracket for positioning the actuator is detached from the vehicle body panel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a vehicle cleaner according to an exemplary embodiment of the present disclosure.

FIG. 2 is an exploded perspective view of the vehicle cleaner.

FIG. 3 is a front view of a first bracket of the vehicle cleaner.

FIG. 4 is a bottom view of the first bracket.

FIG. 5 is a longitudinal cross-sectional view of the vehicle cleaner.

FIG. 6 is a transverse cross-sectional view of the vehicle cleaner.

FIG. 7 is a transverse cross-sectional view illustrating a popped-up state of an injection nozzle of the vehicle cleaner.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

An example of the vehicle cleaner according to an exemplary embodiment of the present disclosure will be described with reference to the drawings. In addition, in the present example, a “left-and-right direction,” a “front-and-rear direction,” and an “up-and-down direction” refer to the relative directions set for the convenience of description with respect to the vehicle cleaner illustrated in the drawings.

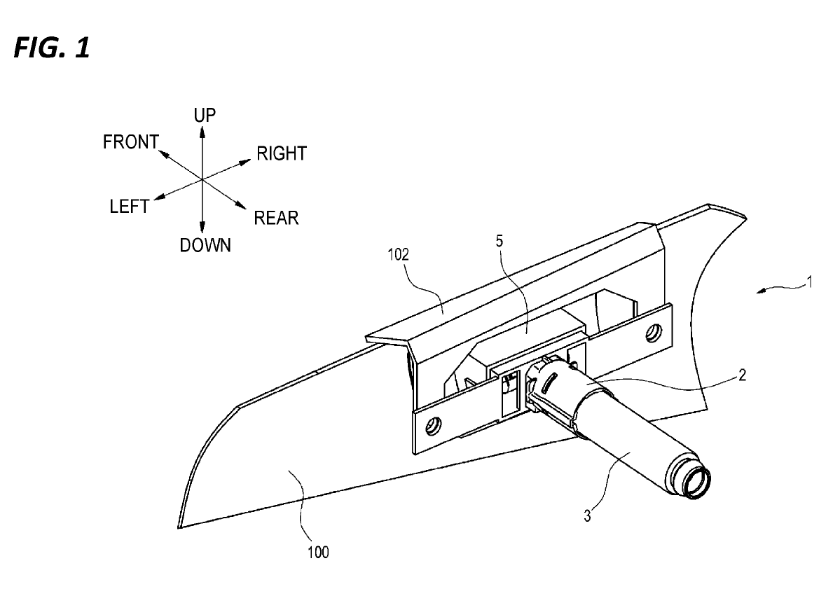

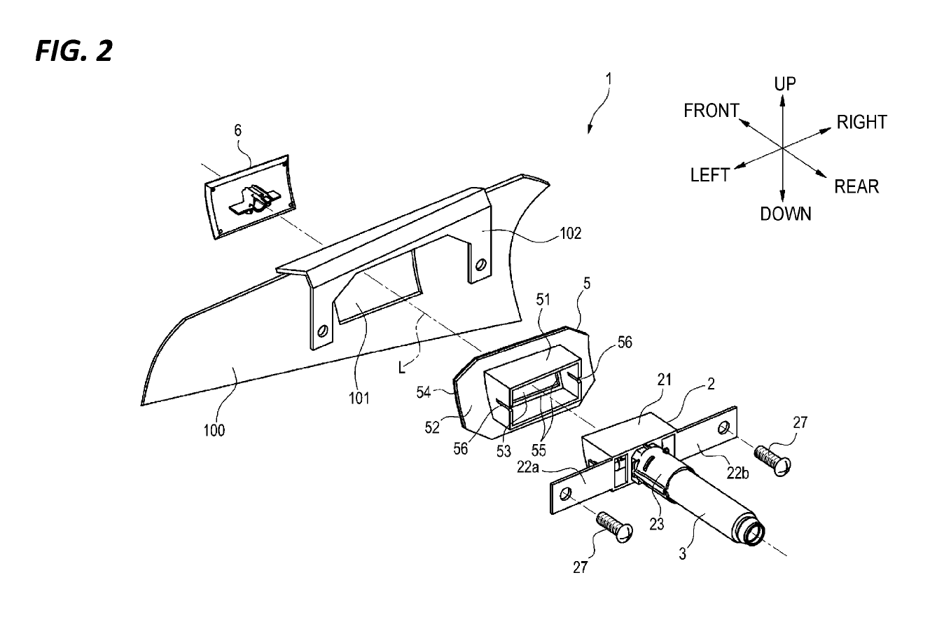

FIG. 1 is a perspective view of a vehicle cleaner 1 attached to a bumper 100 (an example of a vehicle body panel) of a vehicle (hereinafter, referred to as a cleaner 1) when viewed from the upper left rear side. FIG. 2 is an exploded perspective view of the cleaner 1 illustrated in FIG. 1. The cleaner 1 is a cleaner for injecting a cleaning liquid to a lamp (e.g., a headlamp) mounted in a vehicle so as to remove dirt or snow attached to the lamp and clean the lamp.

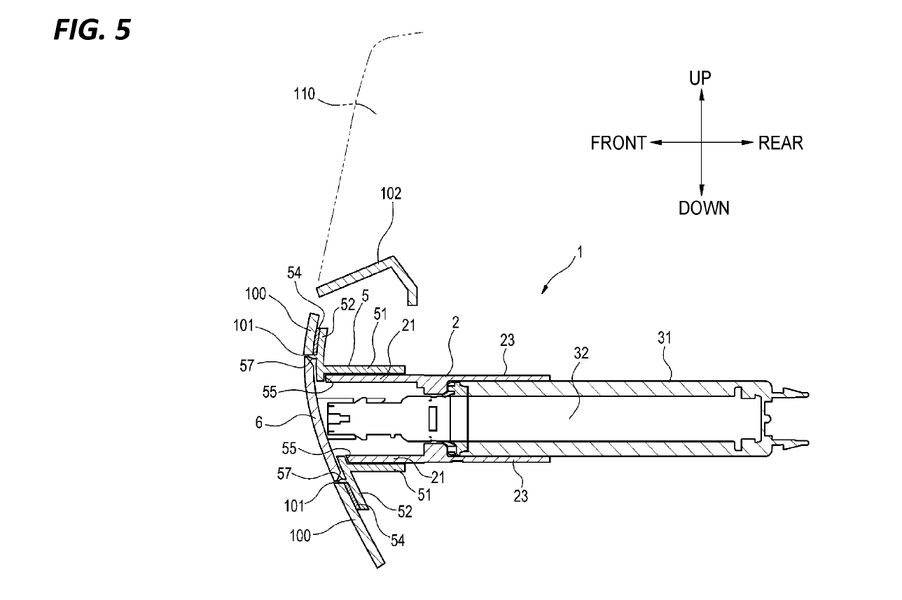

As illustrated in FIGS. 1 and 2, the cleaner 1 includes a first bracket 2, an actuator 3 supported by the first bracket 2, a second bracket 5 to be engaged with the first bracket 2, and a nozzle cover 6 (an example of a cover) provided at the tip of the actuator 6. In addition, a vehicle lamp 110 (an example of a cleaning target) is disposed above the cleaner 1 (see FIG. 5).

The first bracket 2 is a tubular bracket provided within, for example, a rectangular opening 101 formed in a portion of the bumper 100 of the vehicle. The first bracket 2 includes a first rectangular frame body 21 (an example of a first positioning portion), a first attachment portion 22a and a second attachment portion 22b that extend leftward and rightward, respectively, from the rear portion of the first rectangular frame body 21, and a cylindrical frame body 23 that extends rearward from the first rectangular frame body 21.

The actuator 3 is inserted through the first rectangular frame body 21 and the cylindrical frame body 23 of the first bracket 2 so as to be fixed to the first bracket 2. A piston 32 included in the actuator 3 (see FIG. 5) is able to reciprocate in the front-and-rear direction along the central axis L of the actuator 3.

The second bracket 5 is a bracket disposed between the first bracket 2 and the bumper 100. The second bracket 5 includes a second rectangular frame body 51 (an example of a second positioning portion) and a front plate portion 52 attached to the front side of the second rectangular frame body 51.

In the front plate portion 52, an opening 53 is formed in a shape corresponding to the opening 101 of the bumper 100, e.g., a rectangular shape and in a much smaller size than that of the opening 101.

The second rectangular frame body 51 is a rectangular frame body that is formed with a top plate, a bottom plate, and left and right lateral plates so as to have a structure opened in the front-and-rear direction. The opening of the second rectangular frame body 51 which is opened in the front-and-rear direction is formed in the size enough to enable the first rectangular frame body 21 of the first bracket 2 to be inserted into the second rectangular frame body 51. Further, the opening of the second rectangular frame body 51 is formed in the size slightly larger than the opening 53 of the front plate portion 52.

The front plate portion 52 is attached to the front side of the second rectangular frame body 51 in a state where the edge of the opening 53 slightly closes the peripheral portion of the front side opening of the second rectangular frame body 51. Accordingly, when the inside of the second rectangular frame body 51 is viewed from the rear side opening of the second rectangular frame body 51, the edge back surface 55 (an example of an abutment surface) in the opening 53 of the front plate portion 52 slightly protrudes toward the inside of the second rectangular frame body 51.

The front plate portion 52 is fixed to the back surface of the bumper 100 in a state of closing the peripheral portion of the opening 101 of the bumper 100. The front plate portion 52 is fixed to the back surface of the bumper 100 with, for example, an adhesive such as a double-sided tape 54 attached to the front surface of the front plate portion 52. In addition, a protrusion 57 is provided on the front surface of the front plate portion 52 to position the second bracket 5 relative to the opening 101 of the bumper 100 (see FIGS. 5 to 7). The protrusion 57 is formed in a rectangular frame shape that corresponds to the shape of the opening 101.

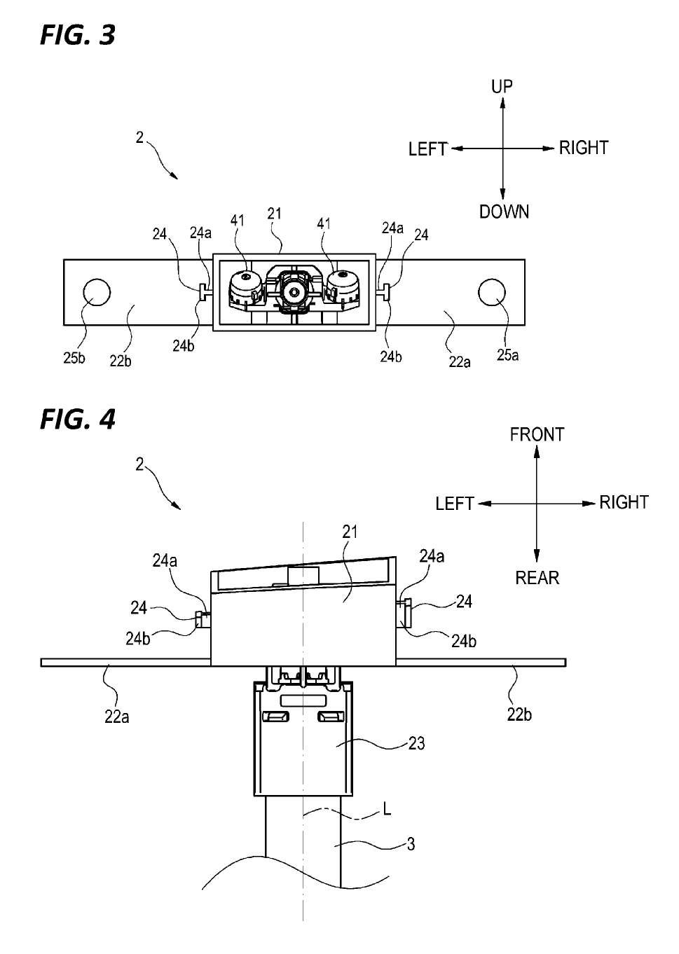

In the left and right lateral plates of the second rectangular frame body 51, guide grooves 56 (an example of a second position portion) are formed to extend in the front-and-rear direction along the central axis L which is the reciprocation direction of the actuator 3. Guide protrusions 24 formed in the first rectangular frame body 21 of the first bracket 2 (to be described later in FIG. 3) may be inserted through the guide grooves 56.

The nozzle cover 6 is attached to the tip of the actuator 3. The nozzle cover 6 is a cover that is able to close the opening 101 of the bumper 100.

In addition, the bumper 100 is provided with a flange 102 for the attachment of the first bracket 2. The flange 102 is used as, for example, a component constituting the vehicle body panel. The first bracket 2 is attached to the bumper 100 in the manner that the first attachment portion 22a and the second attachment portion 22b are fixed to the flange 102 with, for example, screws 27. Thus, the first bracket 2 is fixed to the bumper 100 via the flange 102.

FIG. 3 is a front view of the first bracket 2. In addition, FIG. 4 is a bottom view of the first bracket 2.

As illustrated in FIGS. 3 and 4, the first rectangular frame body 21 of the first bracket 2 is a rectangular frame body formed with a top plate, a bottom plate, and left and right lateral plates, and the forward side of the first rectangular frame body 21 is opened. Injection nozzles 41 are provided near the tip of the actuator 3 to be accommodated in the first rectangular frame body 21. The injection nozzles 41 are nozzles capable of injecting a cleaning liquid toward the lamp 110 of the vehicle.

On the left and right lateral plates of the first rectangular frame body 21, the guide protrusions 24 (an example of a first positioning portion) are provided to extend in the front-and-rear direction along the central axis L which is the reciprocation direction of the actuator 3. Each guide protrusion 24 is formed with, for example, a shaft portion 24a that rises vertically from the corresponding lateral plate and a holding portion 24b that extends perpendicularly to the direction of the shaft portion 24a from the tip portion of the shaft portion 24a. The first bracket 2 and the second bracket 5 are engaged with each other in the manner that the first rectangular frame body 21 is inserted into the second rectangular frame body 51, and simultaneously, the shaft portions 24a of the guide protrusions 24 of the first rectangular frame body 21 are inserted through the guide grooves 56 of the second rectangular frame body 51.

Screw holes 25a and 25b are formed in the first attachment portion 22a and the second attachment portion 22b, respectively. Screws 27 which are used for the attachment to the flange 102 are inserted through the screw holes 25a and 25b. The first attachment portion 22a and the second attachment portion 22b are arranged at positions which are rotationally symmetrical to each other with respect to the central axis L which is the reciprocation direction of the actuator 3. In the present example, each of the first attachment portion 22a and the second attachment portion 22b is formed in a flat plate shape that extends in the left-and-right direction in order to be fixed to the flange 102.

In addition, the shape of the first attachment portion 22a and the second attachment portion 22b is not limited to the flat plate shape. In addition, the first attachment portion 22a and the second attachment portion 22b may be configured to be fixed to the bumper 100 without using the flange 102. In that case, for example, the first attachment portion 22a and the second attachment portion 22b may be formed in a predetermined shape that conforms to the shape of the bumper 100 in order to be fixed to the bumper 100.

The cylindrical frame body 23 is a frame body that determines the installation direction of the actuator 3, and the actuator 3 is inserted through the cylindrical frame body 23.

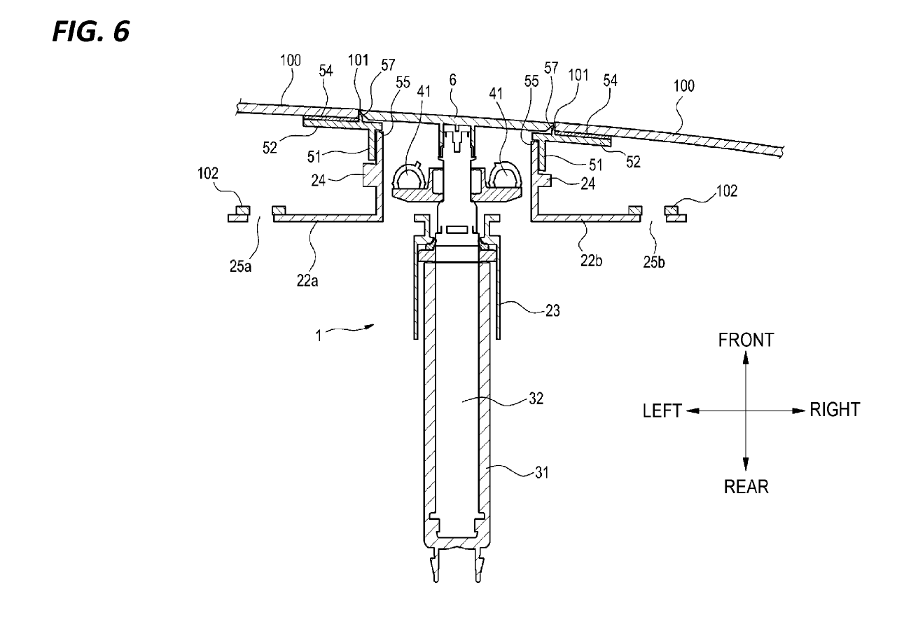

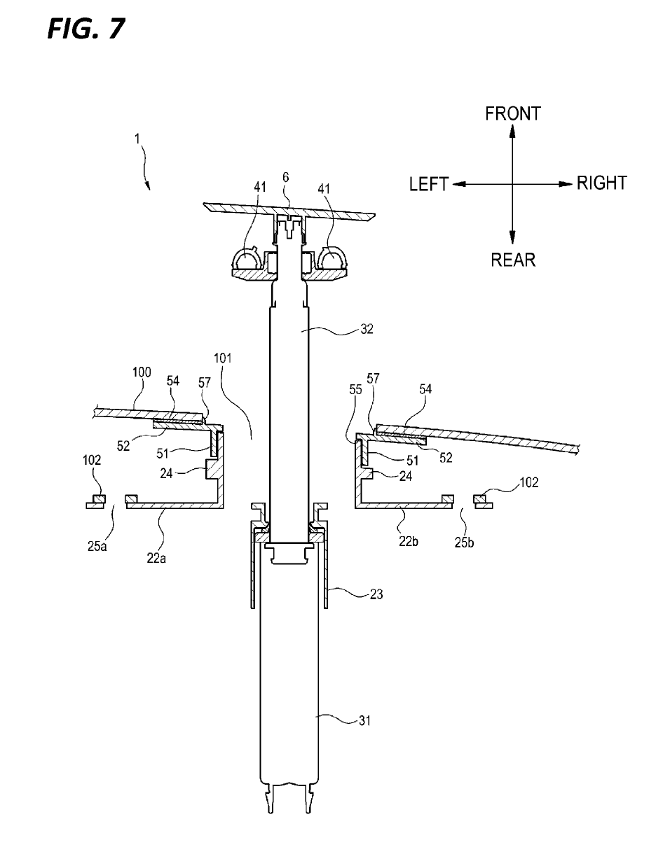

FIG. 5 is a vertical cross-sectional view of the cleaner 1 which is taken by cutting the cleaner 1 vertically across the central axis L. FIG. 6 is a transverse cross-sectional view of the cleaner 1 which is taken by cutting the cleaner 1 transversely across the central axis L. FIG. 7 is a view illustrating a state where the injection nozzles 41 of the cleaner 1 in FIG. 6 are popped up.

As illustrated in FIGS. 5 to 7, the actuator 3 of the cleaner 1 includes a cylinder 31 formed in a cylindrical shape and a piston 32 slidably supported inside the cylinder 31. The piston 32 is able to reciprocate in the front-and-rear direction along the center axis L of the actuator 3 inside the cylinder 31.

The nozzle cover 6 is attached to the tip of the piston 32. The nozzle cover 6 is configured to close the opening 101 of the bumper 100 in a state where the piston 32 is drawn into the cylinder 31 (see FIGS. 5 and 6). That is, the nozzle cover 6 is disposed at a position which is flush with the bumper 100 in a state where the piston 32 is drawn into the cylinder 31.

In addition, the injection nozzles 41 are provided near the tip of the piston 32 on the rear side of the nozzle cover 6. In the present example, a pair of injection nozzles 41 are provided on the left and right sides of the tip portion of the piston 32, respectively (see FIGS. 6 and 7). Each of the injection nozzles 41 has an injection hole, and in a state where the piston 32 protrudes from the opening 101 of the bumper 100, a cleaning liquid such as water or detergent is injected from the injection hole toward the lamp 110 (see FIG. 7).

A method of assembling the cleaner 1 with the configuration described above is as follows. First, in a state where the protrusion 57 is fitted into the opening 101 of the bumper 100, the second bracket 5 is fixed to the back surface of the bumper 100 with the double-sided tape 54 attached to the front surface of the front plate portion 52. Next, the first rectangular frame body 21 is inserted into the second rectangular frame body 51 of the second bracket 5 fixedly positioned in the opening 101, and simultaneously, the guide protrusions 24 of the first rectangular frame body 21 are inserted through the guide grooves 56 of the second rectangular frame body 51. Accordingly, the first bracket 2 is engaged with the second bracket 5. Further, when the first rectangular frame body 21 is inserted into the second rectangular frame body 51, the front surfaces of the respective top plate, bottom plate, and left and right lateral plates that constitute the first rectangular frame body 21 abut onto the edge back surface 55 in the opening 53 of the front plate portion 52 that protrudes inside the second rectangular frame body 51. Then, the first attachment portion 22a and the second attachment portion 22b of the first bracket 2 are screwed to the flange 102 so that the first bracket 2 is fixed to the bumper 100 via the flange 102. In the cleaner 1 assembled in this way, the first bracket 2 is fixed to the bumper 100 via the flange 102 in a state where the guide protrusions 24 of the first bracket 2 are inserted through the guide grooves 56 of the second bracket 5, so that the second bracket 5 is held between the bumper 100 and the first bracket 2.

In addition, in the present example, the cleaner 1 is described as a cleaner for cleaning the lamp 110 (e.g., a headlamp). However, the present disclosure is not limited thereto. For example, the cleaner 1 may be adapted as a cleaner of, for example, an in-vehicle sensor or an in-vehicle camera.

As described above, the cleaner 1 according to the present exemplary embodiment includes: the cylindrical first bracket 2 provided within the opening 101 formed in the bumper 100; the actuator 3 including the cylinder 31 supported by the first bracket 2 and the piston 32 supported to be able to reciprocate in the cylinder 31; the injection nozzles 41 provided near the tip of the piston 32 and configured to inject a cleaning liquid toward the lamp 110 (an example of a cleaning target) in a state where the piston 32 protrudes from the opening 101; the nozzle cover 6 provided at the tip of the piston 32 and configured to close the opening 101 in a state where the piston 32 is drawn into the cylinder 31; and the second bracket 5 attachable to the bumper 100 and configured to position the actuator 3 relative to the opening 101 in a state where the second bracket 5 is engaged with the first bracket 2. The first bracket 2 includes the first attachment portion 22a and the second attachment portion 22b which are arranged at positions rotationally symmetrical to each other with respect to the reciprocation direction of the piston 32 (the central axis L of the actuator 3), and is attachable to the bumper 100 by the first attachment portion 22a and the second attachment portion 22b. According to this configuration, since the first attachment portion 22a and the second attachment portion 22b of the first bracket 2 are arranged at positions rotationally symmetrical to each other with respect to the reciprocation direction of the piston 32, the actuator 3 may be reliably fixed to the bumper 100 by the first attachment portion 22a and the second attachment portion 22b. Further, the second bracket 5 that is used for positioning the actuator 3 in the opening 101 is provided independently from the first bracket 2 that is used for fixing the actuator 3 to the bumper 100. That is, the second bracket 5 does not have the function to fix the actuator 3 to the bumper 100. Thus, for example, even when the double-sided tape 54 of the front plate portion 52 of the second bracket 5 is peeled off so that the second bracket 5 is detached from the bumper 100, the actuator 3 may be reliably fixed by the first attachment portion 22a and the second attachment portion 22b of the first bracket 2. Thus, it is possible to prevent the detached second bracket 5 from hindering the operation of the actuator 3.

In addition, according to the cleaner 1 of the present exemplary embodiment, for example, since the piston 32 slidably supported inside the cylinder 31 may be supported in an appropriate direction, the actuator 3 may smoothly reciprocate.

In addition, according to the cleaner 1 of the present exemplary embodiment, the second bracket 5 is attached in the manner that the rectangular frame-shaped protrusion 57 provided on the front plate portion 52 of the second bracket 5 is inserted into the opening 101 of the bumper 100 so that the inner surface of the opening 101 is in contact with the outer surface of the protrusion 576. Accordingly, the second bracket 5 may be accurately positioned relative to the bumper 100.

In addition, according to the cleaner 1 of the present exemplary embodiment, the first bracket 2 is engaged with the second bracket 5 in the manner that the first rectangular frame body 21 is inserted into the second rectangular frame body 51 of the second bracket 5, and simultaneously, the guide protrusions 24 of the first rectangular frame body 21 are inserted through the guide grooves 56 of the second rectangular frame body 51. Accordingly, the first bracket 2 may be accurately positioned relative to the fixedly positioned second bracket 5. Further, the actuator 3 fixed to the first bracket 2 may be attached to an appropriate position relative to the opening 101 of the bumper 100.

In addition, the front surfaces of the respective top plate, bottom plate, and left and right lateral plates that constitute the first rectangular frame body 21 abut onto the edge back surface 55 in the opening 53 of the front plate portion 52 that protrudes inside the second rectangular frame body 51, so that the nozzle cover 6 attached to the tip of the piston 32 may be accurately positioned relative to the bumper 100. Specifically, the nozzle cover 6 is made flush with the bumper 100 in a state where the piston 32 is drawn into the cylinder 31, so that the opening 101 of the bumper 100 may be closed.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicle cleaner comprising:
a first bracket having a cylindrical shape and provided within an opening formed in a portion of a vehicle body panel of a vehicle;
an actuator including a cylinder supported by the first bracket and a piston supported so as to freely reciprocate in the cylinder;
an injection nozzle provided near a tip of the piston and configured to inject a cleaning liquid toward a cleaning target of the vehicle in a state where the piston protrudes from the opening;
a cover provided at the tip of the piston and configured to cover the opening in a state where the piston is drawn into the cylinder; and
a second bracket attachable to the vehicle body panel and configured to position the actuator relative to the opening in a state where the second bracket is engaged with the first bracket,
wherein the first bracket includes a first attachment portion and a second attachment portion which are arranged at positions rotationally symmetrical to each other with respect to a reciprocation direction of the piston, and is attachable to the vehicle body panel by the first attachment portion and the second attachment portion.

2. The vehicle cleaner of claim 1, wherein the first bracket includes a first positioning portion that positions the actuator relative to the second bracket, and the second bracket includes a second positioning portion in a shape that conforms to a shape of the first positioning portion.

3. The vehicle cleaner of claim 2, wherein the first bracket includes a first rectangular frame body as the first positioning portion, and the second bracket includes a second rectangular frame body in a shape that conforms to a shape of the first rectangular frame body, as the second positioning portion.

4. The vehicle cleaner of claim 2, wherein the first bracket includes a guide protrusion that extends along the reciprocation direction of the piston, as the first positioning portion, and the second bracket includes a guide groove that extends along the reciprocation direction and allows the guide protrusion to be inserted therethrough, as the second positioning portion.

5. The vehicle cleaner of claim 3, wherein the first bracket includes a guide protrusion that extends along the reciprocation direction of the piston, as the first positioning portion, and the second bracket includes a guide groove that extends along the reciprocation direction and allows the guide protrusion to be inserted therethrough, as the second positioning portion.

6. The vehicle cleaner of claim 1, wherein the second bracket has an abutment surface onto which the first bracket abuts when the first bracket is engaged with the second bracket along the reciprocation direction of the piston.

7. The vehicle cleaner of claim 2, wherein the second bracket has an abutment surface onto which the first bracket abuts when the first bracket is engaged with the second bracket along the reciprocation direction of the piston.

8. The vehicle cleaner of claim 3, wherein the second bracket has an abutment surface onto which the first bracket abuts when the first bracket is engaged with the second bracket along the reciprocation direction of the piston.

9. The vehicle cleaner of claim 4, wherein the second bracket has an abutment surface onto which the first bracket abuts when the first bracket is engaged with the second bracket along the reciprocation direction of the piston.

10. The vehicle cleaner of claim 5, wherein the second bracket has an abutment surface onto which the first bracket abuts when the first bracket is engaged with the second bracket along the reciprocation direction of the piston.
